(19) United States
(12) Patent Application Publication
(10) Pub. No.: US 2007/0092616 A1
(43) Pub. Date: Apr. 26, 2007

(54) Puffed snack products and processes for producing the same

(76) Inventors: Philip A. Witte, West Alton, MO (US); Matthew K. McMindes, Chesterfield, MO (US); Luping Ning, St. Louis, MO (US)

Correspondence Address: JAMES L. CORDEK;SOLAE, LLC, PO BOX 88940, St. Louis, MO, 63188, US

(21) Appl. No.: 11/256,354

(22) Filed: Oct. 21, 2005

(51) Int. Cl. A23B 4/03

(52) U.S. Cl. 426/445

(57) ABSTRACT

The present disclosure generally relates to high protein puffed snack products including vegetable protein materials and a non-vegetable protein materials and processes for making high protein puffed snack products. More particularly, the present disclosure relates to high protein puffed snack products including soy protein materials and protein from meat, meat by-products, or dehydrated meat material.

### FIELD OF THE DISCLOSURE

The present disclosure generally relates to high protein puffed snack products including vegetable protein materials and non-vegetable protein materials and processes for making high protein puffed snack products. More particularly, the present disclosure relates to high protein puffed snack products including soy protein materials and protein from meat, meat by-products, and/or dehydrated meat materials.

### BACKGROUND OF THE DISCLOSURE

In recent years, it has become common for consumers to choose foods that are convenient and tasty. Convenient or ready-to-eat foods tend to be nutritionally unbalanced as they may be high in fat and carbohydrates and low in protein. In particular, it is appreciated that the high fat and calorie load of such food products can contribute to obesity and various chronic diseases, such as coronary heart disease, stroke, diabetes, and certain types of cancer.

Generally, vegetable protein materials are eaten in the form of beans or other natural products, but enriched sources such as flour, concentrations, and isolates of defatted oilseed, especially soy, have been developed for use as food ingredients. Soy protein products, in particular, can be good sources for protein because, unlike some other beans, soy offers a “complete” protein profile. Soybeans contain all the amino acids essential to human nutrition, which must be supplied in the diet because they cannot be synthesized by the human body. Additionally, soybeans have the highest protein content of all cereals and legumes.

It is known that many of these vegetable products, such as soy protein products, contain little or no cholesterol. For decades, nutritional studies have indicated that the inclusion of soy protein in the diet actually reduces serum cholesterol levels in people who are at risk. Further, the higher the cholesterol, the more effective soy proteins are in lowering that risk.

While the advantages of vegetable protein materials and, in particular, soy protein materials, are many, consumers also desire food products that have the pleasing tastes and flavors of non-vegetable protein materials. Non-vegetable protein materials such as meat, meat-by products, and dehydrated meat materials, such as beef jerky-type products, are popular food items from a taste perspective, and also provide high levels of protein necessary essential to human nutrition. While such non-vegetable protein materials are generally acceptable from a nutrition standpoint, in many instances they may not be readily converted into products that are convenient, ready-to-eat, portable snack products. Further, such products typically do not contain significant amounts of highly nutritional vegetable protein materials, such as soy protein, that possess the numerous benefits described above.

As is evident from the foregoing, a need exists in the industry for a convenient, ready-to-eat puffed snack product that provides a high concentration of protein and a pleasing taste and texture. Additionally, it would be beneficial if the food product includes both vegetable protein materials and non-vegetable protein materials.

### SUMMARY OF THE DISCLOSURE

The present disclosure relates to high protein puffed snack products. The present disclosure also provides processes for preparing a high protein puffed snack product. The high protein puffed snack products described herein include both vegetable protein materials and non-vegetable protein materials. In one embodiment, the high protein puffed snack products include soy protein isolates and meat protein.

Briefly, therefore, the present disclosure is directed to processes for producing a puffed snack product. In one aspect of the present disclosure, the process includes forming a gel comprising from about 9% (by weight gel) to about 21% (by weight gel) vegetable protein material, from about 0.1% (by gel) to about 50% (by weight gel) non-vegetable protein material, and a hydrating solution. According to this process, the gel is frozen and separated into individual wafers and the individual wafers are dried and heated at a temperature sufficient to expand the individual wafers to produce the puffed snack product.

Another aspect of the present disclosure is a process for producing a puffed snack product, the process including forming a dough comprising from about 1% (by weight dough) to about 80% (by weight dough) vegetable protein material, from about 0.5% (by weight dough) to about 50% (by weight dough) non-vegetable protein material, and a hydrating solution; extruding the dough to form an extrudate; and drying the extrudate to produce the puffed snack product.

Another aspect of the present disclosure is a puffed snack product comprising from about 0.5% (by weight puffed snack product) to about 70% (by weight puffed snack product) vegetable protein; from about 0.1% (by weight puffed snack product) to about 60% (by weight puffed snack product) non-vegetable protein; and from about 1% (by weight puffed snack product) to about 10% (by weight puffed snack product) moisture.

Other objects and features will be in part apparent and in part pointed out hereinafter.

### DETAILED DESCRIPTION OF THE DISCLOSURE

The present disclosure is generally directed to high protein puffed snack products and processes for their manufacture. Specifically, the present disclosure relates to high protein puffed snack products including both vegetable protein material and non-vegetable protein material. It has been found that a high protein puffed snack product including high levels of soy protein materials and high levels of non-vegetable protein such as protein from meat, meat by-products, and/or dehydrated meat material may be produced according to the processes described herein. Additionally, the puffed snack products have a pleasant taste, flavor, and texture.

The high protein puffed snack products of the present disclosure may be produced by a variety of processes as noted herein. Although the precise steps may vary, generally the processes described herein for producing high protein puffed snack products involve forming a gel or a dough including vegetable protein materials and non-vegetable protein materials for use as the starting material. The processes described herein may also include such steps as freezing the gel, separating the gel into individual wafers, drying the individual wafers, and heating the individual wafers to expand the wafers into puffed snack products. Various additional and/or alternative processes may also include such steps as extruding the dough to produce an extrudate, or steps in which the gel is sheeted and further processed. As noted above, however, the various processes for producing the puffed snack product all generally utilize a gel or a dough as the starting material. The various starting materials and processes for producing the puffed snack products are discussed in detail below.

Vegetable Protein Materials for use in the Gel or Dough

As noted above, the various processes for producing the high protein puffed snack products described herein generally involve first forming a gel or a dough including vegetable protein material. Common vegetable protein materials for use in the puffed snack products include proteins from cereal grains (e.g., wheat, corn, rice, oats, barley, rye, sorghum, etc.). Other common vegetable protein materials for use in the puffed snack products include proteins from legumes (e.g., lupine, favabean, pea bean, mung bean, field pea, lima bean, lentil, chickpeas, etc.). Still other common vegetable protein materials for use in the puffed snack products include proteins from oilseeds (e.g., soybean, sunflower, canola, peanut, cottonseed, flaxseed, linseed, sesame seed, etc.). Preferably, the gel or dough includes a soy protein material. Suitable soy protein materials include soy flakes, soy flour, soy grits, soy meal, soy protein concentrates, soy protein isolates, and mixtures thereof. The primary difference between these soy protein materials is the degree of refinement relative to whole soybeans.

Soy flakes are generally produced by dehulling, defatting, and grinding the soybean and typically contain less than about 65% (by weight) soy protein on a moisture-free basis. Soy flakes also contain soluble carbohydrates, insoluble carbohydrates such as soy fiber, and fat inherent in soy. Soy flakes may be defatted, for example, by extraction with hexane. Soy flours, soy grits, and soy meals are produced from soy flakes by comminuting the flakes in grinding and milling equipment such as a hammer mill or an air jet mill to a desired particle size. The comminuted materials are typically heat treated with dry heat or steamed with moist heat to “toast” the ground flakes and inactivate anti-nutritional elements present in soy such as Bowman-Birk and Kunitz trypsin inhibitors. Heat treating the ground flakes in the presence of significant amounts of water is avoided to prevent denaturation of the soy protein in the comminuted materials and to avoid costs involved in the addition and removal of water from the soy material. The resulting ground, heat treated material is a soy flour, soy grit, or a soy meal, depending on the average particle size of the material. Soy flour generally has a particle size of less than about 150 μm. Soy grits generally have a particle size of about 150 μm to about 1000 μm. Soy meal generally has a particle size of greater than about 1000 μm.

In one embodiment, the vegetable protein material in gel or dough is soy flour or soy protein concentrate. Soy protein concentrates typically contain about 65% (by weight dry basis) to less than 90% (by weight dry basis) soy protein, with the major non-protein component being fiber. Soy protein concentrates are typically formed from defatted soy flakes by washing the flakes with either an aqueous alcohol solution or an acidic aqueous solution to remove the soluble carbohydrates from the protein and fiber. Suitable commercially available soy protein concentrates for use in the gel or dough include, for example, Promine® DS, Procon® 2000, and Cenpro® 70, available from The Solae Company, St. Louis, Mo.

In a preferred embodiment, the vegetable protein material in the gel or dough is soy protein isolates, which are highly refined soy protein materials. Specifically, soy protein isolates are processed to contain at least 90% (by weight dry basis) soy protein and little or no soluble carbohydrates or fiber. Soy protein isolates are typically formed by extracting soy protein and water soluble carbohydrates from defatted soy flakes or soy flour with an alkaline aqueous extractant. The aqueous extract, along with the soluble protein and soluble carbohydrates, is separated from materials that are insoluble in the extract, mainly fiber. The extract is typically then treated with an acid to adjust the pH of the extract to the isoelectric point of the protein (about pH 4.5) to precipitate the protein from the extract. The precipitated protein is separated from the extract, which retains the soluble carbohydrates, and is dried after being adjusted to a neutral pH or is dried without any pH adjustment. Numerous variations of the standard methods described above for producing a soy protein isolate are also known to those of skill in the art. For example, some processes utilize ultrafiltration membranes to separate the desired soy protein materials from the less desirable materials. Other processes may substitute water for the aqueous alkaline solution during the extraction step. The exact procedure used to produce the soy protein isolates utilized in the gel and/or dough is not narrowly critical and suitable processes are known to one of skill in the art.

Additionally, numerous commercially available soy protein isolates can be used as a component of the gel and/or dough described herein. Suitable commercially available soy protein isolates for use in the gel or dough include, for example, SUPRO® 670, SUPRO® 661, SUPRO® Ex38, and SUPRO® 500E, available from The Solae Company, St. Louis, Mo.

Non-Vegetable Protein Materials for use in the Gel or Dough

As noted above, the gel or dough used in producing the high protein puffed snack product also includes non-vegetable protein material. As utilized herein, non-vegetable protein material refers to meat, meat by-products, or dehydrated meat material. The term “meat” is understood to apply not only to the flesh of cattle, swine, sheep, and goats, but also horses, whales, and other mammals, along with poultry and fish and shellfish. The term “meat by-products” is intended to refer to those non-rendered parts of the carcass of slaughtered animals including but not limited to mammals, poultry, fish and the like. The term “dehydrated meat materials” refers to meat materials which are substantially free of moisture, such as dried meats or jerky-type products.

The percentage of meat protein in meats, meat by-products, and dehydrated meat materials is relatively variable, typically depending on the overall composition of the meat material. For example, the amount of meat protein in 95% lean beef is typically from about 20% (by weight) to about 21% (by weight) meat protein. By way of another example, the amount of meat protein in 90% lean beef is typically from about 19% (by weight) to about 20% (by weight) meat protein. By way of another example, the amount of meat protein in 80% lean beef is typically from about 18% (by weight) to about 19% (by weight) meat protein. By way of another example, the amount of meat protein in 70% lean beef is typically from about 15% (by weight) to about 16% (by weight) meat protein. By way of another example, the amount of meat protein in SlimJim® meat snacks is typically from about 14% (by weight) to about 20% (by weight) meat protein. By way of another example, the amount of meat protein in meat jerky is typically from about 18% (by weight) to about 35% (by weight) meat protein.

Examples of meat which may be used as a component in the gel or dough are mammalian meat such as beef, veal, pork, and horsemeat, and the fleshy tissue from antelope, bison, cows, deer, elk, and the like, of varying fat content (e.g., 95% lean, 80% lean, 75% lean, 50% lean, 30% lean, etc.). Poultry meat which may be used as a component in the gel or dough includes chicken, turkey, duck, goose, and the like, and the various parts and skins thereof, which may or may not be mechanically deboned. Meat also includes the flesh of fish and shell fish. Meat also includes ground or processed meat of any of the above mammals and fish. Meat also includes striated muscle which is skeletal or that which is found, for example, in the tongue, diaphragm, heart, or esophagus, with or without accompanying overlying fat and portions of the skin, sinew, nerve and blood vessels which normally accompany the meat flesh. Examples of meat by-products are organs and tissues such as skins (e.g., pork skins or rinds), lungs, spleens, kidneys, brain, liver, blood, bone, partially defatted low-temperature fatty tissues, stomachs, intestines free of their contents, and the like. Poultry by-products include non-rendered clean parts of carcasses of slaughtered poultry such as heads, feet, and viscera, free from fecal content and foreign matter. Examples of dehydrated meat material includes such materials as dried meat products, meat jerky, and sausage products such as SlimJim® meat snacks, summer sausage, and the like.

Other Ingredients in the Gel or Dough

In addition to the foregoing, the gel or dough may also include other additives and agents conventionally employed in snack products, along with those known in the art. Such additives and agents include, for example, milk or milk by-products, egg or egg by-products, cheese, salt, monosodium glutamate, pepper, garlic, onion, or other additives and flavorings commonly used for flavoring snack products. In various embodiments, the gel or dough may also include soluble carbohydrates such as sugars, maltodextrin, and soluble fibers, also including cereals such as rice (e.g., rice flour), wheat, corn, and barley, and tubers and roots such as potatoes (e.g., native potato starch), and tapioca (e.g., native tapioca starch). Insoluble carbohydrates such as soy fiber, oat fiber, wheat fiber, pea fiber, and cellulose among others, may also be included in the gel or dough as a processing aid.

Conventional snack flavoring agents may also be readily mixed into the gel or dough. These agents and additives may be soluble in the hydrating solution, or may be insoluble and visible in or on the gel or dough after it is formed and/or after it undergoes additional processing steps.

Commonly-used flavoring agents in snack food processing include, for example, pizza, barbecue, sour cream, chives, onion, garlic, italian flavoring, smoke flavoring, teriyaki flavoring, sweet and sour flavoring, hot seasoning, spicy seasoning, butter, vinegar, ranch, bacon, chicken, beef, cheese, ham, and nacho flavorings, dried vegetable flakes and herb flakes such as pepper, basil, thyme, peppermint, dried tomato, and parsley flakes, condiment flakes, spices, cheese powders such as cheddar cheese and nacho cheese seasoning powders, and mixtures thereof. Any flavoring agent typically employed in snack products and known in the art may be used. These flavoring agents generally enhance the flavor of the puffed snack product, provide a color property to the puffed snack product and/or provide structure to the gel or dough. For example, salt may be added to the gel or dough for flavor and also to enhance the structure of the gel or dough. Typically, the gel or dough includes from about 0.1% (by weight) to about 5% (by weight) flavoring agent. Alternatively, if the flavoring agents are applied to the puffed snack product in combination with an oil or edible adhesive, the puffed snack product typically includes from about 0.1% (by weight puffed snack product) to about 20% (by weight puffed snack product) flavoring agent/oil or edible adhesive combination.

Alternatively, the above-described flavoring agents may be sprinkled, brushed, or otherwise applied to the product during other steps in the process. For example, at various points during the processes described herein, the product may be sprayed with oil or an edible no-fat, low-fat or reduced fat edible adhesive. The oil or adhesive is used to increase palatability and to provide a medium for the adhesion of the above-described flavoring agents. The flavoring agents may be applied after spray coating with the oil or adhesive or they may be applied together, for example, as a slurry. A slurry coating applicator such as a Coatronic applicator (Allen International, Newberg, Oreg.), or a rotating disk applicator such as sold by Arcall Ltd., (Dorset, England), for example, may be used. The products may also be optionally subjected to tumbling during the spraying and/or during the addition of the particulate additives and agents.

In addition to the various flavoring agents, the gel or dough may also further include one or more curing and/or preserving agents, if so desired. Curing and/or preserving agents are generally used to prevent meats from spoiling when cooked or smoked at relatively low temperatures (e.g., under about 60° C. (140° F.)). Curing and/or preserving agents are also generally used to prevent growth of microorganisms, for adding flavor, and for preserving the color of the meat. Accordingly, the use of such preservatives and/or curing agents may be particularly useful in puffed snack products including non-vegetable protein material such as meat, meat by products, and dehydrated meat materials. Examples of preservatives and/or curing agents which can be included in the gel or dough are benzoic acid, the sodium and other salts of benzoic acid, the sodium, calcium and other salts (i.e., propionates) of propionic acid, sorbic acid, the potassium, calcium, sodium and other salts (i.e., sorbates) of sorbic acid, diethyl pyrocarbonate and menadione sodium bisulfate, and sodium nitrite. One particularly suitable curing and/or preserving composition is Prague Powder #1 (also known as Insta-Cure #1 or Modem Cure #1), which is a mixture of sodium nitrite (6.25%) and salt (93.75%). Another suitable curing and/or preserving composition is Prague Powder #2 (also known as Insta-Cure #2 or Modern Cure #2), which is a mixture of sodium nitrite (1 oz) and sodium nitrate (0.64 oz) per one pound of salt. Typically, the gel or dough includes from about 0.1% (by weight) to about 5% (by weight) of one or more curing and/or preserving agents.

The Freezing Process for Producing a Puffed Snack Product

In one embodiment, the process for producing the puffed snack product of the present disclosure comprises forming a gel including vegetable protein material and non-vegetable protein material; freezing the gel; separating the gel into individual wafers; drying the individual wafers; and heating the individual wafers at a temperature sufficient to expand the individual wafers into a puffed snack product.

According to this embodiment, the gel is generally formed by contacting the vegetable protein material and the non-vegetable protein material with a hydrating solution. As noted above, the gel serves as the starting material in the various processes described herein for producing the puffed snack product. As used herein, the term hydrating generally refers to the introduction of water to the vegetable protein materials and the non-vegetable protein materials.

Suitably, the vegetable protein material and the non-vegetable protein material is contacted with the hydrating solution until the hydrating solution is uniformly absorbed throughout the vegetable protein material and the non-vegetable protein material, forming a gel. More specifically, after hydrating is completed, the vegetable protein materials and the non-vegetable protein materials will typically have no visible dry spots. More suitably, neither the vegetable protein materials nor the non-vegetable protein materials will be distinguishable in the mixture. Preferably, the vegetable protein materials and the non-vegetable protein materials are mixed with the hydrating solution until the mixture resembles a glassy or translucent gel. The presence of the glassy or translucent gel generally indicates that the vegetable protein materials and the non-vegetable protein materials have been sufficiently hydrated and that the gel has been formed.

Typically, the gel has a moisture content of from about 75% (by weight gel) to about 85% (by weight gel). Preferably, the gel has a moisture content of from about 78% (by weight gel) to about 83% (by weight gel). More preferably, the gel has a moisture content of from about 79% (by weight gel) to about 81% (by weight gel). The moisture content of the gel may be measured using a microwave moisture analyzer such as those commercially available from Omnimark Instrument Corp. (Tempe, Ariz.).

Typically, the vegetable protein material is first contacted with the hydrating solution to form an aqueous slurry. The aqueous slurry is then mechanically worked by conventional mixing equipment. A bowl cutter, which is used extensively in the food processing industry, is generally preferred. Suitable bowl cutters for use in the present disclosure are commercially available from such manufacturers as Seydelmann (Germany), Kramer & Grebe (Germany), and Fatosa (Spain). Typically, the aqueous slurry is mechanically worked, e.g., with a bowl cutter, for about 4 minutes to about 10 minutes. More preferably, the aqueous slurry is mechanically worked for from about 6 minutes to about 8 minutes.

Next, the non-vegetable protein material is contacted with the above described mixture (i.e., the hydrating solution and the vegetable protein material) and the resulting mixture is further mechanically worked to form a gel. Typically, the non-vegetable protein materials are comminuted (e.g., with a bowl chopper) prior to adding them to the mixture including the hydrating solution and the vegetable protein materials. For example, when dehydrated meat material, such as meat jerky or SlimJim® meat snacks, is employed as the non-vegetable protein material, it is preferably mixed or ground into a smooth paste or powder prior to adding it to the mixture including the hydrating solution and the vegetable protein materials. Preferably, the non-vegetable protein material is finely ground into granules or particles of uniform size and consistency. More preferably, the non-vegetable protein material is ground such that the granules or particles will pass through a U.S. #10 mesh sieve.

The gel will typically be formed by further mechanically working the hydrating solution, the vegetable protein material, and the non-vegetable protein material for about 3 minutes to about 5 minutes after the addition of the non-vegetable protein material. Alternatively, the hydrating solution, the vegetable protein material, and the non-vegetable protein material may be mixed for up to about 10 minutes or up to about 15 minutes after the non-vegetable protein material is added. As described above, the gel is a smooth or glassy/translucent gel having a rigid or plastic-like consistency; therefore the mixture may be mechanically worked for any such time period as is necessary to form a composition having these characteristics. Suitably, the gel has a gel strength of about 9,000 to about 15,000 grams. The gel strength may be measured using a texture analyzer such as the TAXT2 texture analyzer (Stable Micro Systems Ltd., England).

Suitably, the gel is formed by contacting the vegetable protein material and the non-vegetable protein material with a sufficient amount of a hydrating solution comprising water. In one preferred embodiment, the hydrating solution is water. In some embodiments, the amount of hydrating solution comprising water (by weight) is preferably about four times the amount of vegetable protein material (by weight). If substantially less water is used, the subsequently-produced gel may not be sufficiently hydrated for further processing steps. If substantially more water is used, the subsequently-produced gel may be over-hydrated for further processing steps. For example, if the gel contains too much water, the product will not expand as well during the subsequent expansion (i.e., puffing) steps. By way of another example, if more hydrating solution comprising water is used, the cost of manufacturing may increase as excess water may have to be removed from the gel during subsequent processing steps, such as the drying and/or heating steps described in further detail below. It should be understood, however, that the amount of water used to form the gel may depend on a number of factors including, for example, the desired properties of the final puffed snack product and/or any of the various process steps employed to produce such product.

As will be understood by one of skill in the art, the foregoing ingredients (e.g., vegetable protein material, non-vegetable protein material, hydrating solution, and other ingredients) may be mixed to form the gel in any particular order. For example, the vegetable protein material, non-vegetable protein material, and the hydrating solution may be contacted with each other at substantially the same time and mixed to form the gel. By way of another example, the vegetable protein material may be contacted with the hydrating solution first and mixed to homogeneity, and this mixture may be further contacted with the non-vegetable protein material and mixed to produce the gel, and vice versa. Alternatively, the vegetable protein material and the non-vegetable protein material may be first mixed to homogeneity (e.g., dry mixed), and this mixture may be further contacted with the hydrating solution to produce the gel. The other ingredients, such as flavoring agents, may similarly be mixed with the vegetable protein material and the non-vegetable protein material at any point and in any particular order during the gel formation process.

In this embodiment, the gel generally comprises from about 9% (by weight gel) to about 21% (by weight gel) vegetable protein material. More preferably, the gel comprises from about 11% (by weight gel) to about 19% (by weight gel) vegetable protein material; still more preferably from about 13% (by weight gel) to about 19% (by weight gel) vegetable protein material. Exemplary vegetable protein materials for use in this embodiment are described in detail above. Preferably, the vegetable protein materials are soy protein materials. More preferably, the vegetable protein materials are soy protein isolates.

The gel also preferably comprises from about 0.1% (by weight gel) to about 50% (by weight gel) non-vegetable protein material. More preferably, the gel comprises from about 1% (by weight gel) to about 15% (by weight gel) non-vegetable protein material; still more preferably from about 1% (by weight gel) to about 10% (by weight gel) non-vegetable protein material; still more preferably from about 3% (by weight gel) to about 7% (by weight gel) non-vegetable protein material. Preferably, the non-vegetable protein materials are selected from the group consisting of meat, meat by-products, dehydrated meat materials, and combinations thereof. Exemplary meat materials for use in this embodiment are also described in detail above.

The gel also preferably comprises from about 38% (by weight gel) to about 79% (by weight gel) hydrating solution. More preferably, the gel comprises from about 54% (by weight gel) to about 79% (by weight gel) hydrating solution; still more preferably from about 66% (by weight gel) to about 79% (by weight gel) hydrating solution. According to this embodiment, it is generally preferred that the amount of hydrating solution (by weight) is about four times the amount of vegetable protein material (by weight). Preferably, the hydrating solution is water.

The gel may also include one or more of the various additives and/or flavoring agents described in detail above. In one embodiment, the gel comprises a flavoring agent. Preferably, the gel comprises from about 0.5% (by weight gel) to about 3% (by weight gel) of a flavoring agent comprising salt.

After the gel is formed, it is generally frozen to allow for easy processing and to provide additional structure to the gel matrix. Freezing is typically performed by placing the gel into a freezer having a temperature of about −17° C. or less. Alternatively, the freezer may have a temperature of about −23° C. or less; or, the freezer may have a temperature of about −29° C. or less. This freezing step results in a gel having both a hard, frozen outer surface and inner core. The gel is typically substantially frozen solid. Typically, the gel is placed in a freezer overnight in order to achieve sufficient freezing. Alternatively, however, the gel could remain in the freezer for any number of days, weeks, months, or years, and be removed when it was convenient to further process the gel into the puffed snack product of the present disclosure.

After freezing, the gel is separated (e.g., cut, sliced, or otherwise portioned or sectioned) into individual wafers. The frozen gel may be slightly thawed, e.g., to a substantially semi-solid state, to facilitate separation into individual wafers. Depending on the shape of the frozen gel, various shapes may be produced upon separating such as, for example, square wafers, round wafers, rectangular wafers, triangular wafers, and the like. The gel may be separated using a conventional deli meat slicer. For example, the gel may be separated into individual wafers being from about 0.5 millimeters to about 4 millimeters thick; preferably about I millimeter thick. At this point, the individual wafers preferably have a moisture content of from about 50% (by weight wafer) to about 80% (by weight wafer); more preferably from about 65% (by weight wafer) to about 76% (by weight wafer).

The freezing process may also optionally include introducing the gel into a casing material prior to freezing. The casing material enables improved handling and sectioning of the individual wafers. One suitable casing material is an impermeable material such as a clear or opaque polyvinylidene chloride (PVDC) tube (e.g., Saran wrap®). The casing material is then generally sealed to enclose the gel therein. Other suitable casing materials include conventional sausage casing materials, such as natural casings made of animal viscera, such as sheep, hog, or beef intestines, animal-derived collagen, such as from the corium layer of split beef hides, or cellulose casings, which are inedible and are typically peeled off the sausage product prior to consumption. Generally speaking, the gel may be wrapped in conventional sausage casing materials or extruded (i.e., stuffed) into such casing materials using conventional sausage preparation methods. For example, the gel may be stuffed into a casing material using a vacuum stuffer (such as those commercially available from Handtmann, Inc. (Buffalo Grove, Ill.)) or a piston stuffer (such as those commercially available from Koch Supplies, Inc. (Kansas City, Mo.) prior to freezing. Alternatively, the gel may be coextruded with a soy protein dough casing material, as disclosed in U.S. patent application Ser. No. 11/199,891 (hereby incorporated by reference herein). Typically, the encased gel has a diameter of about 3 centimeters to about 4 centimeters.

The freezing process for producing the puffed snack product may also optionally include sheeting the gel and separating the sheeted gel into individual wafers. The separating step may be performed either before or after freezing. For example, the gel could be sheeted, frozen, and separated into individual wafers which may then undergo further processing steps. Alternatively, the gel could be sheeted, separated into individual wafers, frozen, and then undergo further processing steps.

Sheeting the gel can eliminate the need for encasing the gel in a casing such as PVDC or conventional sausage casings. Suitable “sheeting and cutting” (i.e., sheeting and separating) equipment is well known in the food processing industry and includes, for example, Rondo sheeters and sheeter/cutters (commercially available from Rondo Inc., Moonachie, N.J.) and the Somerset® CDR-2000 Dough Sheeter (commercially available from Somerset Industries, Inc. (North Billerica, Mass.)).

After the gel is separated into individual wafers, the individual wafers are dried to achieve a desired moisture content. Generally speaking, the individual wafers should be dried to a sufficient level of moisture to allow good expansion (i.e., puffing) in the subsequent processing steps.

In order to achieve good expansion, the moisture level of the dried individual wafers is preferably not too high or too low. In some embodiments, individual wafers that have a moisture content of less than about 5% (by weight individual wafer) will not expand as well during subsequent processing steps. Similarly, in some embodiments, individual wafers that have a moisture content of more than about 30% (by weight individual wafer) will not expand as well during subsequent processing steps. In order for sufficient expansion to occur during the subsequent processing steps, the individual wafers produced according to this embodiment are typically dried to a moisture content of greater than about 5% (by weight individual wafer). The individual wafers are typically dried to a moisture content of less than about 30% (by weight individual wafer). Preferably, the individual wafers produced according to this embodiment are dried to a moisture content of from about 8% (by weight individual wafer) to about 15% (by weight individual wafer).

Typically, the individual wafers produced according to the freezing process are then dried in an oven. It will be understood by one of skill in the art, however, that the individual wafers may be stored (e.g., in a freezer) for any number of days, weeks, months, or years, and removed when it was convenient to further process the wafers.

The oven used for drying the individual wafers may be a direct gas-fired oven, a hot air impingement oven, a forced air convection oven, an indirect radiation oven, an infra-red oven, a microwave oven, combinations thereof, and the like. Preferably, the oven is a convection oven. It will be understood by one of ordinary skill in the art that the term convection oven also includes smokehouses. The drying time is generally from about 2 minutes to about 2 hours. The end point for the drying of the individual wafers is dictated, however, by the desired moisture level of the dried wafers and/or the presence or absence of subsequent processing steps.

In one embodiment, the individual wafers are dried in a smokehouse. There are numerous smokehouse and/or convection oven cooking and smoking procedures known to those of skill in the art, any of which may be used to dry the individual wafers to a desired moisture content. For example, the temperature and humidity of the smokehouse may be varied considerably. Preferably, at least some moisture is present in the convection oven to prevent case hardening of the individual wafers. Case hardening may occur if the outer surface(s) of the individual wafer dry too rapidly and become hard. This may prevent the internal portion of the individual wafers from drying to the desired moisture content.

One method of monitoring the temperature and humidity of a smokehouse is through the use of a dry bulb/wet bulb thermometer. The dry bulb/wet bulb thermometer monitors the temperature of the smokehouse using two thermometers positioned next to each other, one dry, and the other inside a moist piece of cloth. The difference between the dry and wet bulb temperatures can be used to calculate the relative humidity of the smokehouse, e.g., using a psychrometric chart. The wet bulb temperature is essentially a measurement of the temperature at which moisture is evaporating in the oven. The wet bulb temperature in an oven can be controlled in one of two ways. The smokehouse control system can either modulate fresh air and/or exhaust dampers open and closed to regulate the amount of evaporated moisture from the individual wafers that is retained in the oven. Alternatively, the smokehouse control system can control the wet bulb temperature by injecting steam or atomized water into the oven as a humidity source. In one preferred embodiment, the individual wafers are dried in a smokehouse (i.e., convection oven) at 82° C. (180° F.) dry bulb and 63° C. (146° F.) wet bulb for from about 2 minutes to about 2 hours.

After the individual wafers are dried to a desired moisture content, the dried wafers are heated at a temperature sufficient to expand (i.e., puff) the wafers to produce a puffed food product. The gel structure of wafer, coupled with the proper amount of moisture, will cause the wafer to expand or puff. More specifically, the puffing or expansion occurs when the moisture in the individual wafer flashes off to steam upon heating. Depending on how fast the moisture is flashed to steam, the puffing or expansion may occur relatively rapidly or relatively slowly.

As noted above, the expansion or puffing step generally involves subjecting the wafer to heating conditions. The heating may be conducted, for example, with hot air frying, oil or deep fat frying, microwave heating, oven heating, heating with a puffing gun such as those used in the cereal industry, with hot sand, combinations thereof, and the like. The puffing operation expands the wafer and produces an expanded, structured, textured, porous product having cells formed by the sudden release of moisture contained within the wafer. It is typically desirable to conduct the expansion or puffing step under conditions (e.g., moisture, time, and temperature conditions) which obviate the development of undesired taste, flavor, discoloration, and the like. Further, the expansion or puffing step is preferably conducted under conditions which cause substantially all of the wafer to puff substantially uniformly. As noted above, the individual wafers have a diameter of from about 3 centimeters to about 4 centimeters. Preferably, the individual wafers are expanded to about 4 centimeters to about 10 centimeters in diameter during the heating step. More preferably, the individual wafers are expanded to about 6.5 centimeters to about 7 centimeters in diameter during the heating step.

In one embodiment, the dried individual wafers are fried in hot oil to produce the puffed snack product. For example, the dried individual wafers can be fried in hot oil at a temperature of from about 196° C. (385° F.) to about 218° C. (425° F.) to produce the puffed snack product. Preferably, the dried individual wafers can be fried in hot oil at a temperature of from about 199° C. (390° F.) to about 204° C. (400° F.). Various conventional cooking oils such as vegetable oil, canola oil, soybean oil, sunflower oil, combinations thereof, and the like may be used to fry the wafer to expansion. Animal fats such as tallow and lard may also be used as the frying medium.

During the hot oil frying process, the majority of free water in the individual wafers will be replaced with oil. It is desirable to minimize this oil uptake, however, as this will lead to a healthier, low fat snack product. As such, the frying time of the individual wafers is generally short, typically from about 1 second to about 2 seconds. A longer frying time may be required if batches of the puffed snack product are being produced, as opposed to, e.g., one wafer at a time. For example, in batch-type processing, the wafers are typically fried for about 10 seconds to about 15 seconds.

Another suitable heating method for expanding the dried individual wafers into the puffed snack product includes using a microwave oven. For example, the individual wafers can be microwaved at from about 1000 Watts to about 1200 Watts for a time of from about 15 seconds to about 30 seconds to produce the puffed snack product. In batch-type processing, the wafers may require a longer time period for microwave heating, e.g., about 2 minutes to about 4 minutes.

Yet another suitable method for expanding the dried individual wafers into the puffed snack product includes using a hot air impingement oven or convection oven. A commercially available hot air impingement oven which may be used is manufactured by Werner & Pfleider, Ramsey, N.J., or APV Baker, Inc., Grand Rapids, Mich. Preferably, the individual wafers are cooked in an air impingement oven for a time period of from about 15 seconds to about 30 seconds to produce the puffed snack product. In batch-type processing, the wafers may require a longer time period for microwave heating, e.g., about 2 minutes to about 4 minutes.

One difference between the various heating methods for producing the puffed snack product is the length of time required for the moisture in the individual wafer(s) to flash off into steam. As noted above, when the moisture in the wafer flashes off into steam the puffing or expansion of the wafer occurs. Hot oil frying typically causes instantaneous or substantially instantaneous flashing of the moisture in the individual wafer into steam, while other methods such as microwave or convection oven heating typically require longer periods of time before expansion. Generally speaking, it takes longer for the moisture in the wafers to flash off into steam in microwaves or convection ovens because the heating is more gradual, whereas in hot oil frying, the wafers are immediately subjected to a temperature sufficient to cause the moisture to flash off into steam.

The puffed snack product produced according to the foregoing process generally comprises from about 0.5% (by weight puffed snack product) to about 70% (by weight puffed snack product) vegetable protein; more preferably from about 10% (by weight puffed snack product) to about 50% (by weight puffed snack product) vegetable protein; still more preferably from about 20% (by weight puffed snack product) to about 40% (by weight puffed snack product) vegetable protein; still more preferably from about 21% (by weight puffed snack product) to about 35% (by weight puffed snack product) vegetable protein; most preferably from about 21% (by weight puffed snack product) to about 31% (by weight puffed snack product) vegetable protein.

The puffed snack product produced according to the foregoing process also generally comprises from about 0.1% (by weight puffed snack product) to about 60% (by weight puffed snack product) non-vegetable protein; more preferably from about 0.1% (by weight puffed snack product) to about 30% (by weight puffed snack product) non-vegetable protein; still more preferably from about 0.2% (by weight puffed snack product) to about 20% (by weight puffed snack product) non-vegetable protein; still more preferably from about 0.2% (by weight puffed snack product) to about 15% (by weight puffed snack product) non-vegetable protein; most preferably from about 0.2% (by weight puffed snack product) to about 7% (by weight puffed snack product) non-vegetable protein.

One method of measuring the vegetable protein and non-vegetable protein content is by the Kjeldahl or Kjel-Foss analysis. For example, the Nitrogen-Ammonia-Protein Modified Kjeldahl Method according to AOCS Methods Bc4-91 (1997), Aa 5-91 (1997), and Ba 4d (1997) may be used to determine the protein content of the puffed snack product.

The puffed snack product produced according to the foregoing process also generally comprises from about 1% (by weight puffed snack product) to about 10% (by weight puffed snack product) moisture. More preferably, the puffed snack product comprises from about 1% (by weight puffed snack product) to about 4% (by weight puffed snack product) moisture; most preferably from about 2% (by weight puffed snack product) to about 3% (by weight puffed snack product) moisture.

The puffed snack product may also comprise from about 0.1% (by weight puffed snack product) to about 20% (by weight puffed snack product) of a flavoring agent. More preferably, the puffed snack product comprises from about 1% (by weight puffed snack product) to about 10% (by weight puffed snack product) of a flavoring agent. As noted above, the flavoring agent may be combined with an oil or other edible adhesive. The flavoring agents are described in detail above.

The Extrusion Process for Producing the Puffed Snack Product

In another embodiment, the process for producing the puffed snack product of the present disclosure comprises forming a dough including vegetable protein material and non-vegetable protein material and extruding the dough to produce a puffed snack product. The extrusion process may also include various drying steps described in further detail below.

According to this embodiment, the dough is formed during the extrusion process described below. The dough generally comprises from about 1% (by weight dough) to about 80% (by weight dough) vegetable protein material. More preferably, the dough comprises from about 10% (by weight dough) to about 50% (by weight dough) vegetable protein material; still more preferably from about 20% (by weight dough) to about 25% (by weight dough) vegetable protein material. Exemplary vegetable protein materials for use in this embodiment are described in detail above. Preferably, the vegetable protein materials are soy protein materials. More preferably, the vegetable protein materials are soy protein isolates.

The dough also preferably comprises from about 0.5% (by weight dough) to about 50% (by weight dough) non-vegetable protein material. More preferably, the dough comprises from about 1% (by weight dough) to about 20% (by weight dough) non-vegetable protein material; still more preferably from about 2% (by weight dough) to about 10% (by weight dough) non-vegetable protein material. Preferably, the non-vegetable protein materials are selected from the group consisting of meat, meat by-products, dehydrated meat materials, and combinations thereof. Exemplary meat materials for use in this embodiment are described in detail above.

The dough may also include one or more of the various additives and/or flavoring agents described in detail above. In one embodiment, the dough comprises a flavoring agent. Preferably, the dough comprises from about 0.5% (by weight dough) to about 3% (by weight dough) of a flavoring agent comprising salt.

The dough also typically includes a hydrating solution. Preferably, the hydrating solution is water. The amount of hydrating solution in the dough is an important component in the extrusion process. For example, water is an important parameter in producing a puffed snack product having a crisp and crunchy texture via extrusion. An adequate amount of hydrating solution is also generally needed to allow sufficient hydration of the vegetable protein material and the non-vegetable protein material. Insufficient amounts of hydrating solution used during various parts of the extrusion process may result in difficulties in producing an extruded product, or may damage the extrusion equipment.

In addition to the vegetable protein material, non-vegetable protein material, and hydrating solution, the dough used in the extrusion process may also contain one or more soluble carbohydrates in an amount of from about 0.25% (by weight dough) to about 5% (by weight dough) soluble carbohydrates on a moisture-free basis. Suitable sources of soluble carbohydrates are described above.

In addition to soluble carbohydrates, the dough may also include insoluble carbohydrates such as soy fiber, oat fiber, wheat fiber, pea fiber, and cellulose, among others. Insoluble carbohydrates generally do not contribute to nutritive carbohydrate load. They are typically present as an aid in processing of the dough via extrusion, because the fiber serves to facilitate flowability and expansion of the mixture in the extruder. When soy fiber is present in the dough to serve either as filler to increase the volume of the mixture or as a processing aid, the amount of fiber present can vary widely. Generally, however, the dough comprises from about 0.25% (by weight dough) to about 10% (by weight dough) fiber. Soy fiber absorbs moisture as the extrusion mass flows through the extrusion barrel to the die. A higher soy fiber content, however, may reduce the amount of expansion of the extrudate to produce a tougher, denser product. A modest concentration of soy fiber is believed to be effective in obstructing cross-linking of protein molecules, thus preventing excessive gel strength from developing in the cooked extrusion mass exiting the die. Unlike the protein materials, which also absorb moisture, soy fiber readily releases moisture upon release of pressure at the die exit temperature. Flashing of the moisture released contributes to expansion, i.e., “puffing,” of the extrudate, thus conducing to the formation of the puffed snack product of the present disclosure.

A suitable extrusion process generally involves mixing the particular dry ingredients (e.g., the vegetable protein material, the non-vegetable protein material, and other dry ingredients such as carbohydrates, fiber, flavoring additives and agents, etc.) until a homogenous mix is formed. Typically, this is performed by blending for about 20 minutes with a Hobart mixer, a well known mixer in the food processing industry. The homogenous dry mix typically has a moisture content of about 5-10% (by weight); preferably, the moisture content is about 7% (by weight). The homogenous dry mix is then fed into a pre-conditioner to form a conditioned protein mixture. The feed rate of the dry mix to the pre-conditioner is typically about 50 kg/hr to about 60 kg/hr. The conditioned protein mixture is then fed to an extrusion apparatus (i.e., extruder) in which the protein mixture is heated under mechanical pressure generated by the screws of the extruder to form the dough. The dough exits the extruder through an extrusion die to form an extrudate.

In the pre-conditioner, the particulate solid ingredient mix is preheated, contacted with moisture (i.e., steam and/or water), and held under controlled temperature and pressure conditions to allow the moisture to penetrate and soften the individual particles. Typically, water is injected at a rate of from about 2 kg/hr to about 7 kg/hr. The preconditioning step increases the bulk density of the particulate protein mixture and improves its flow characteristics. The pre-conditioner contains one or more paddles to promote uniform mixing of the vegetable protein material and non-vegetable protein material and transfer of the mixture through the pre-conditioner. The configuration and rotational speed of the paddles vary widely, depending on the capacity of the pre-conditioner, the extruder throughput and/or the desired residence time of the protein mixture in the pre-conditioner or extruder barrel. Generally, the speed of the paddles is from about 500 to about 1300 revolutions per minute (rpm). Preferably, the speed of the paddles is about 700 revolutions per minute (rpm).

Typically, vegetable protein material and non-vegetable protein material mixture is pre-conditioned prior to introduction into the extrusion apparatus by contacting the dry pre-mix with moisture (i.e., steam and/or water) at a temperature of at least about 30° C. (86° F.). Substantially higher temperatures (i.e., temperatures above 85° C. (185° F.)) in the pre-conditioner may encourage starches to gelatinize, which in turn may cause lumps to form, which may impede flow of the protein mixture from the pre-conditioner to the extruder barrel.

Typically, the pre-mix is conditioned for a period of from about 30 to about 60 seconds, depending on the speed and the size of the conditioner. The pre-mix is contacted with steam and/or water and heated in the pre-conditioner at generally constant steam flow to achieve the desired temperatures. The water and/or steam conditions (i.e., hydrates) the pre-mix, increases its density, and facilitates the flowability of the dried mix (via the formation of the dough) without interference prior to introduction to the extruder barrel where the dough is expanded (i.e., puffed).

The dough typically includes from about 2% to about 60% (by weight dough) water. Preferably, the dough includes from about 5% to about 30% (by weight dough) water. Generally, as the bulk density of the dough increases within this range, the dough is easier to process. This is believed to be due to such mixtures occupying all or a majority of the space between the screws of the extruder, thereby facilitating conveying the dough through the barrel, forming an extrudate.

Extrusion devices have long been used in the manufacture of a wide variety of edible products. One suitable extrusion device is a double-barrel, twin screw extruder as described, for example, in U.S. Pat. No. 4,600,311. Examples of commercially available double-barrel, twin screw extrusion apparatus include a CLEXTRAL Model BC-72 extruder manufactured by Clextral, Inc. (Tampa, Fla.); a WENGER Model TX-57 extruder manufactured by Wenger (Sabetha, Kans.); and a WENGER Model TX-52 extruder manufactured by Wenger (Sabetha, Kans.). Other conventional extruders suitable for use in this disclosure are described, for example, in U.S. Pat. Nos. 4,763,569, 4,118,164, and 3,117,006, which are hereby incorporated by reference herein.

The screws of a twin screw extruder can rotate within the barrel in the same (co-rotating) or opposite directions (counter-rotating). Rotation of the screws in the same direction is referred to as single flow whereas rotation of the screws in opposite directions is referred to as double flow (counter-rotating). Typically, co-rotating twin screw extruders are used in the manufacturing of puffed snack products.

The speed of the screw or screws of the extruder may vary depending on the particular apparatus. However, the screw speed is typically from about 200 to about 600 revolutions per minute (rpm). Generally, as the screw speed increases, the density of the extrudates decreases. Particularly, the screw speed of the twin screw extruder may effect residence time of the dough in the extruder, the amount of shear generated, and the degree of cooking of the dough; as the screw speed increases, residence time decreases, and the amount of shear increases.

Among other things, conventional extruder systems generally act as an ingredient mixer (e.g., to form the dough), mixture cooker, and composition (extrudate) former. Each of these functions can be accomplished in the same cooking extruder. In some instances, however, it may be desirable to have at least two extruders arranged in a series. The initial extruders generally serve to mix the ingredients, heat the mixture, impart both heat and mechanical work to the mixture, and substantially cook the mixture. The later extruders generally serve to prepare the mixture into a puffed snack product extrudate or an extrudate (e.g., pellet) having the desired attributes to form a puffed snack product after further processing. It can therefore be readily seen that the processes described herein for producing a puffed snack product can include one extruder or a series of sequential extruders, if an extrusion step is so desired.

The extrusion apparatus also generally includes one or more heating zones through which the dough is conveyed under mechanical pressure prior to exiting the extrusion apparatus through an extrusion die. The temperature in each successive heating zone generally exceeds the temperature of the previous heating zone by between about 10° C. and about 50° C. (between about 50° F. and about 122° F.). Alternatively, one or more of the heating zones may have the same temperature as the previous heating zone. In one embodiment, the dough is transferred through four heating zones within the extrusion apparatus, with the dough heated to a temperature of from about 40° C. to about 110° C. (from about 104° F. to about 230° F.) such that the dough enters the extrusion die at a temperature of from about 40° C. to about 110° C. (from about 104° F. to about 230° F.).

The pressure within the extruder barrel is not narrowly critical. Typically the extrusion mass is subjected to a pressure of at least about 400 psi (about 28 bar) and generally the pressure within the last two heating zones is from about 800 psi to about 3000 psi (from about 55 bar to about 210 bar). In one embodiment the pressure of the last heating zone is from about 900 psi to about 1000 psi (from about 62 bar to about 70 bar). The barrel pressure is dependent on numerous factors including, for example, the extruder screw speed, feed rate of the mixture to the barrel, feed rate of water to the barrel, and the viscosity of the dough within the barrel.

Water is also injected into the extruder barrel to further hydrate the dough. As an aid in forming the dough the water may also act as a plasticizing agent. Water may be introduced to the extruder barrel via one or more injection jets in communication with a heating zone. Typically, water is injected at a rate of from about 2 kg/hr to about 7 kg/hr. The mixture in the barrel typically contains from about 15% to about 30% (by weight) water. The rate of introduction of water to any of the heating zones is generally controlled to promote production of an extrudate having desired characteristics. It has been observed that as the rate of introduction of water to the barrel decreases, the density of the extrudate decreases. The dough in the extrusion apparatus is extruded through a die to produce an extrudate. Preferably, the die is a 3 mm orifice die.

Extrusion conditions are generally such that the extrudate emerging from the extruder barrel typically has a moisture content of from about 5% to about 20% (by weight extrudate). In one embodiment, the moisture content of the extrudate is from about 5% (by weight extrudate) to about 15% (by weight extrudate). In another embodiment, the moisture content of the extrudate is about 10% (by weight extrudate). The moisture content is derived from water present in the mixture introduced to the extruder, moisture added during preconditioning and/or any water injected into the extruder barrel during processing.

Upon release of pressure, the dough exits the extruder barrel through the die, superheated water present in the mass flashes off as steam, causing simultaneous expansion (i.e., puffing) of the material. The level of expansion of the extrudate upon exiting of the mixture from the extruder in terms of the ratio of the cross-sectional area of extrudate to the cross-sectional area of die openings is generally less than about 50:1. Typically, the ratio of the cross-sectional area of extrudate to the cross-sectional area of die openings is from about 2:1 to about 50:1.

The cross-section of the extrudate generally consists of numerous round or substantially round cells. These cells are substantially uniform in size, shape, and thickness of cell wall. The cells are also typically connected such that the cell generally shares a wall with an adjacent cell. The density of the extrudate is typically from about 0.02 g/cm³ to about 0.2g/cm³.

The extrudate is cut after exiting the die. Suitable apparatus for cutting the extrudate include flexible knives manufactured by Wenger (Sabetha, Kans.) and Clextral (Tampa, Fla.).

Various die orifice designs will cause different expansions and geometric shapes of the extrudate. For example, depending on the geometric shape of the extrudate, the sliced or cut extrudate may be in the shape of a sheet, disc, pellet, rod, string, bar, and the like, or some other shape.

In some instances the extrusion processes described above produces substantially expanded (i.e., puffed) extrudates. Accordingly, it may be desirable to dry the extrudates to a final moisture content as opposed to a moisture content that will facilitate further expansion (e.g., by heating). Dryers used to dry the extrudates generally comprise a plurality of drying zones in which the air temperature may vary. Generally, the temperature of the air within one or more of the zones will be from about 100° C. to about 185° C. (from about 212° F. to about 370° F.). In one embodiment, the temperature is about 121° C. (about 250° F.). Typically, the extrudate is present in the dryer for a time sufficient to provide a puffed snack product having a desired moisture content. This desired moisture content may vary widely depending on the intended application of the product and, typically, is from about 0.5% to about 5.0% by weight. Generally, the extrudate is dried for at least about 5 minutes and, more generally, for at least about 10 minutes. Suitable dryers include those manufactured by Wolverine Proctor & Schwartz (Merrimac, Mass.), National Drying Machinery Co. (Philadelphia, Pa.), Wenger (Sabetha, Kans.), Clextral (Tampa, Fla.), and Buehler (Lake Bluff, Ill.).

Alternatively, the extrusion process may also be used to produce extrudates that require additional processing steps such as drying or further expansion steps to produce the puffed snack product. These products are typically referred to as pellets. Suitably, the pellets are dried using one or more of the various drying methods described above in the freezing process embodiment above. For example, the pellets may be dried with a convection oven or in a smokehouse. The pellets are preferably dried to a moisture content of from about 10% (by weight pellet) to about 20% (by weight pellet).

The dried pellets may then be heated to a temperature sufficient to produce a puffed snack product using the various heating methods described above in the freezing process embodiment above. For example, the dried pellets may be expanded (i.e., puffed) with such methods as hot air frying, deep fat frying, microwave heating, with a puffing gun such as those used in the cereal industry, with hot sand, combinations thereof, and the like.

After the various expansion steps have been performed, the puffed extrudate (or the expanded pellet) may be coated or sprinkled with an oil such as vegetable oil. The oil may also be combined with the conventional snack food additives and agents described above. The oil and other additives and agents typically contribute to about 0.1% (by weight puffed snack product) to about 20% (by weight puffed snack product) of the puffed snack product; more preferably from about 5% (by weight puffed snack) to about 20% (by weight puffed snack); still more preferably from about 5% (by weight puffed snack) to about 15% (by weight puffed snack). Alternatively, the additives and agents may be combined with a hydrocolloid such as gum arabic and applied to the puffed snack product. The hydrocolloid and other additives and agents typically contribute to about 0.1% (by weight puffed snack product) to about 20% (by weight puffed snack product).

The puffed snack product produced according to the foregoing process generally comprises from about 0.5% (by weight puffed snack product) to about 70% (by weight puffed snack product) vegetable protein; more preferably from about 10% (by weight puffed snack product) to about 50% (by weight puffed snack product) vegetable protein; still more preferably from about 20% (by weight puffed snack product) to about 40% (by weight puffed snack product) vegetable protein; still more preferably from about 21% (by weight puffed snack product) to about 35% (by weight puffed snack product) vegetable protein; most preferably from about 21% (by weight puffed snack product) to about 31% (by weight puffed snack product) vegetable protein.

The puffed snack product produced according to the foregoing process also generally comprises from about 0.1% (by weight puffed snack product) to about 60% (by weight puffed snack product) non-vegetable protein; more preferably from about 0.1% (by weight puffed snack product) to about 30% (by weight puffed snack product) non-vegetable protein; still more preferably from about 0.2% (by weight puffed snack product) to about 20% (by weight puffed snack product) non-vegetable protein; still more preferably from about 0.2% (by weight puffed snack product) to about 15% (by weight puffed snack product) non-vegetable protein; most preferably from about 0.2% (by weight puffed snack product) to about 7% (by weight puffed snack product) non-vegetable protein.

One method of measuring the vegetable protein and non-vegetable protein content is by the Kjeldahl or Kjel-Foss analysis. For example, the Nitrogen-Ammonia-Protein Modified Kjeldahl Method according to AOCS Methods Bc4-91 (1997), Aa 5-91 (1997), and Ba 4d (1997) may be used to determine the protein content of the puffed snack product.

The puffed snack product produced according to the foregoing process also generally comprises from about 1% (by weight puffed snack product) to about 10% (by weight puffed snack product) moisture. More preferably, the puffed snack product comprises from about 1% (by weight puffed snack product) to about 6% (by weight puffed snack product) moisture; most preferably from about 1.5% (by weight puffed snack product) to about 3% (by weight puffed snack product) moisture.

The puffed snack product may also comprise from about 0.1% (by weight puffed snack product) to about 20% (by weight puffed snack product) of a flavoring agent. More preferably, the puffed snack product comprises from about 5% (by weight puffed snack product) to about 15% (by weight puffed snack product) of a flavoring agent. As noted above, the flavoring agent may be combined with an oil or other edible adhesive.

Having described the invention in detail, it will be apparent that modifications and variations are possible without departing the scope of the invention defined in the appended claims. Furthermore, it should be appreciated that all examples in the present disclosure are provided as non-limiting examples.

### EXAMPLE 1

### Preparation of a Puffed Snack Product Using a Freezing Process

In this Example, various high protein puffed snack products are produced using the sample gel and control gel formulations set forth in Table 1:

TABLE 1
SAMPLE GEL AND CONTROL GEL FORMULATIONS

| | Vegetable Protein | | | Beef (95% | Beef (75% | Beef (50% | Chicken MDM | Prague Powder |
|---|---|---|---|---|---|---|---|---|
| SAMPLE GEL | Material (kg) | Water (kg) | Salt (kg) | lean) (kg) | lean) (kg) | lean) (kg) | (85% lean) (kg) | #1 (kg) |
| 1 | 3.72 | 14.878 | 0.4 | 1.0 | 0 | 0 | 0 | 0.002 |
| 2 | 3.519 | 14.076 | 0.4 | 2.0 | 0 | 0 | 0 | 0.005 |
| 3 | 3.319 | 13.275 | 0.4 | 2.999 | 0 | 0 | 0 | 0.007 |
| 4 | 3.098 | 12.494 | 0.4 | 3.998 | 0 | 0 | 0 | 0.003 |
| 5 | 2.72 | 10.878 | 0.4 | 5.999 | 0 | 0 | 0 | 0 |
| 6 | 18.0 | 72.0 | 2.0 | 0 | 10.0 | 0 | 0 | 0.025 |
| 7 | 18.0 | 72.0 | 2.0 | 0 | 0 | 10.0 | 0 | 0.025 |
| 8 | 18.0 | 72.0 | 2.0 | 0 | 0 | 0 | 10.0 | 0.025 |
| CONTROL 1 | 3.922 | 15.686 | 0.392 | 0 | 0 | 0 | 0 | 0 |
| CONTROL 2 | 20.0 | 80.0 | 2.0 | 0 | 0 | 0 | 0 | 0 |

The high protein puffed snack products are prepared by first grinding the non-vegetable protein material (i.e., beef (95%, 75%, or 50% lean) or chicken MDM (85% lean) with a meat grinder with a ½″ grind for about 1-3 minutes, followed by a ¼″ grind for about 1-3 minutes. Separately, the vegetable protein material (commercially available as SUPRO® Ex33 from The Solae Company, St. Louis, Mo.) and the hydrating solution (water) are chopped with a bowl chopper for about 4-5 minutes and then added to the powdered non-vegetable protein material. The salt and curing agent (Prague Powder #1) are also added to the powdered non-vegetable protein material and the resulting mixture was further chopped for about 3-4 minutes to produce a gel. The gel has a gel strength of about 10,000-13,000 grams, as measured with a texture analyzer (TA.XT2, available from Stable Micro Systems Ltd., England). As illustrated in Table 1, two control gel mixtures are also prepared without the non-vegetable protein material and the curing agent.

The sample gels and control gels formed by the above process are then stuffed into sausage casings using a sausage stuffer (available from Handtmann Inc., Buffalo Grove, Ill.). The encased gels are then introduced into a freezer having a temperature of about −3.8° C. to −2.2° C. (25° F.-28° F.) to freeze the encased gels.

The next day, the frozen encased gels are removed and the formed gels were sliced into individual wafers having a thickness of about 1-2 millimeters using a deli meat slicer. The individual wafers are placed on a perforated tray, which had been sprayed with baker's oil (commercially available as Bak-klene from Cahokia Flour Co.) and dried in a smokehouse having a dry bulb temperature of about 82.2° C. (180° F.) and a wet bulb temperature of about 63.3° C. (145° F.) for about 1-2 hours. After drying, the individual wafers have a moisture content of about 8-10% (by weight).

The dried individual wafers are then fried in vegetable oil having a temperature of about 204.4° C. (400° F.) for about 10-15 seconds to produce the puffed snack product. The puffed snack product has a vegetable protein content of about 30-40% (by weight puffed snack product), a non-vegetable protein content of about 0.5-5.0% (by weight puffed snack product), and a moisture content of about 2-3% (by weight puffed snack product).

### EXAMPLE 2

### Preparation of a Puffed Snack Product Using an Extrusion Process

In this Example, various high protein puffed snack products are produced by an extrusion process using the dry mixture formulations set forth in Table 2:

TABLE 2
SAMPLE DOUGH AND CONTROL
DOUGH FORMULATIONS

| Dry ingredients | Sample 1 | Sample 2 |
|---|---|---|
| Soy protein isolate (kg) | 46.9 | 42.8 |
| Corn flour (kg) | 44.8 | 44.8 |
| Rice flour (kg) | 40.8 | 40.8 |
| Sugar (kg) | 2.7 | 2.7 |
| Salt (kg) | 0.7 | 0.7 |
| Dehydrated meat jerky (kg) | 0 | 4.1 |
| TOTAL (kg) | 135.9 | 135.9 |

First, the various dry ingredients (dehydrated meat jerky, soy protein isolate (SUPRO® 670, available from The Solae Company, St. Louis, Mo.), flour, salt, and sugar) are mixed in a Hobart mixer until a homogenous dry mixture is formed. As illustrated in Table 2, Sample 1 does not contain non-vegetable protein material. Accordingly, the physical and chemical characteristics of the dough in the extruder necessitate modification of the various extrusion parameters.

The above dry mixtures are first fed into a pre-conditioner at a feed rate of about 59 kg/hr for Sample 1 and about 50 kg/hr for Sample 2. The temperature of the pre-conditioner is maintained at about 38° C. for Sample 1 and about 50° C. for Sample 2. Steam and water are injected into the pre-conditioner at a rate of about 3 kg/hr for Sample 1 and about 6 kg/hr for Sample 2 to hydrate the various dry ingredients. The mixing paddles in the pre-conditioner are running at about 700 rpm for each sample. The sample mixture is then fed into a Wenger TX52 twin screw extruder (available from Wenger, Sabetha, Kans.). The extruder has four progressive heating zones set at temperatures of 50° C., 49° C., 106° C., and 104° C. for Sample 1 and at temperatures of 44° C., 45° C., 101° C., and 110° C. for Sample 2, respectively. The screw speed was set at about 350 rpm for Sample 1 and about 415 rpm for Sample 2. A single hole 3 millimeter orifice die was used to set the geometry of the finished product for each sample.

The pre-conditioned dough is introduced into the extruder barrel and cooked therein with mechanical energy from the extruder screw rpm/shear and electrical energy at the above temperature zones. The pressure of the extruder in the last zone is about 1000 psi for Sample 1 and about 900 psi for Sample 2. The extruder is running at a rate of about 0.83 kg/min (1.83 lb/min) for each sample. The moisture content of the extrudate off the extruder is measured at about 10% (by weight) for each sample. The density of the extrudate is measured at about 0.047 g/cm³ for Sample 1 and about 0.074 g/cm³ for Sample 2. Density is measured by filling up a cup (1150 cm³) with the extrudate and measuring the weight of the extrudate (density=weight/1150 cm³).

The extrudate is then dried in a forced air convection oven (tray dryer no. 65974, National Drying Machinery Co., Philadelphia, Pa.) at about 121° C. (250° F.) for about 10 minutes to produce a puffed snack product having a moisture content of about 2%. The resulting puffed snack product is then seasoned with a vegetable oil seasoning mixture. The puffed snack product produced from Sample 2 has a vegetable protein content of about 27% (by weight puffed snack product), a non-vegetable protein content of about 0.7% (by weight puffed snack product), a moisture content of about 2.5 (by weight puffed snack product), a vegetable oil flavoring content of about 10% (by weight puffed snack product), and a smoke-flavored seasoning content of about 10% (by weight puffed snack product).

What is claimed is:

1. A process for producing a puffed snack product, the process comprising:
forming a gel comprising from about 9% (by weight gel) to about 21% (by weight gel) vegetable protein material, from about 0.1% (by weight gel) to about 50% (by weight gel) non-vegetable protein material, and a hydrating solution;
freezing the gel;
separating the gel into individual wafers;
drying the individual wafers; and
heating the individual wafers at a temperature sufficient to expand the individual wafers to produce the puffed snack product.

2. The process as set forth in claim 1 wherein the soy protein materials are soy protein isolates.

3. The process as set forth in claim 1 wherein the non-vegetable protein material is selected from the group consisting of meat, meat by-products, dehydrated meat material, and combinations thereof.

4. The process as set forth in claim 1 wherein the gel comprises from about 38% (by weight gel) to about 79% (by weight gel) hydrating solution.

5. The process as set forth in claim 4 wherein the hydrating solution comprises water.

6. The process as set forth in claim 1 wherein the gel is introduced into a casing prior to freezing.

7. The process as set forth in claim 6 wherein the casing material is selected from polyvinylidene (PCVD), collagen, cellulose, animal viscera, coextrudable soy protein dough casings, and combinations thereof.

8. The process as set forth in claim 1 wherein the gel is sheeted prior to being separated into individual wafers.

9. The process as set forth in claim 1 wherein the drying is performed by a drying means selected from the group consisting of a convection oven, a smokehouse, an air impingement oven, and combinations thereof.

10. The process as set forth in claim 9 wherein the wafers are heated by oil frying at a temperature of from about 196° C. to about 218° C.

11. A process for producing a puffed snack product, the process comprising:
forming a dough comprising from about 1% (by weight dough) to about 80% (by weight dough) vegetable protein material, from about 0.5% (by weight dough) to about 50% (by weight dough) non-vegetable protein material, and a hydrating solution;
extruding the dough to form an extrudate; and
drying the extrudate to produce the puffed snack product.

12. The process as set forth in claim 11 wherein the soy protein materials are soy protein isolates.

13. The process as set forth in claim 11 wherein the non-vegetable protein material is selected from the group consisting of meat, meat by-products, dehydrated meat material, and combinations thereof.

14. The process as set forth in claim 11 wherein the dough comprises from about 2% (by weight dough) to about 60% (by weight dough) hydrating solution.

15. The process as set forth in claim 14 wherein the hydrating solution comprises water.

16. The process as set forth in claim 11 wherein the drying is performed by a drying means selected from the group consisting of a convection oven, an air impingement oven, and combinations thereof.

17. The process as set forth in claim 11 further comprising heating the puffed snack product after drying the extrudate.

18. The process as set forth in claim 17 wherein the extrudate is heated by oil frying at a temperature of from about 196° C. to about 218° C.

19. A puffed snack product comprising:
from about 0.5% (by weight puffed snack product) to about 70% (by weight puffed snack product) vegetable protein;
from about 0.1% (by weight puffed snack product) to about 30% (by weight puffed snack product) non-vegetable protein; and
from about 1% (by weight puffed snack product) to about 10% (by weight puffed snack product) moisture.

20. The puffed snack product as set forth in claim 19 wherein the puffed snack product comprises from about 20% (by weight puffed snack product) to about 40% (by weight puffed snack product) vegetable protein.

21. The puffed snack product as set forth in claim 19 wherein the puffed snack product comprises from about 21% (by weight puffed snack product) to about 31% (by weight puffed snack product) vegetable protein.

22. The process as set forth in claim 20 wherein the vegetable protein comprises soy protein isolates.

23. The puffed snack product as set forth in claim 19 wherein the puffed snack product comprises from about 0.2% (by weight puffed snack product) to about 20% (by weight puffed snack product) non-vegetable protein.

24. The puffed snack product as set forth in claim 19 wherein the puffed snack product comprises from about 0.2% (by weight puffed snack product) to about 7% (by weight puffed snack product) non-vegetable protein.

25. The puffed snack product as set forth in claim 19 wherein the non-vegetable protein comprises protein from the group consisting of meat, meat by-products, dehydrated meat, and combinations thereof.

26. The puffed snack product as set forth in claim 25 wherein the non-vegetable protein comprises protein from the group consisting of beef, pork, poultry, fish, and combinations thereof.

27. The puffed snack product as set forth in claim 26 wherein the non-vegetable protein comprises protein from the group consisting of dehydrated beef, dehydrated chicken, dehydrated pork, dehydrated poultry, dehydrated fish, and combinations thereof.

28. The puffed snack product as set forth in claim 19 wherein the puffed snack product comprises from about 1% (by weight puffed snack product) to about 4% (by weight puffed snack product) moisture.

29. The puffed snack product as set forth in claim 19 wherein the puffed snack product further comprises from about 0.1% (by weight puffed snack product) to about 20% (by weight puffed snack product) of a flavoring agent.

30. The puffed snack product as set forth in claim 26 wherein the flavoring agent is selected from the group consisting of pizza, barbecue, sour cream, chives, onion, garlic, italian flavoring, smoke flavoring, teriyaki flavoring, sweet and sour flavoring, hot seasoning, spicy seasoning, butter, vinegar, ranch, bacon, chicken, beef, cheese, ham, nacho flavorings, dried vegetable flakes, herb flakes, pepper, basil, thyme, peppermint, dried tomato, parsley flakes, condiment flakes, spices, cheese powders, cheddar cheese and nacho cheese seasoning powders, and mixtures thereof.
